(19) United States
(12) Patent Application Publication
(10) Pub. No.: US 2025/0001667 A1
(43) Pub. Date: Jan. 2, 2025

(54) Method for Monitoring a Film Bubble, and a Film-Blowing Installation

(71) Applicant: Windmöller & Hölscher KG, Lengerich (DE)

(72) Inventors: Ingo Hehmann, Lengerich (DE); Marco Ventker-Stegemann, Lengerich (DE); Michel Bembenek, Lengerich (DE); Sebastian Glose, Neuenkirchen (DE); Markus Bussmann, Münster (DE)

(21) Appl. No.: 18/710,794

(22) PCT Filed: Nov. 22, 2022
(86) PCT No.: PCT/EP2022/082782

§ 371 Date: May 16, 2024

(30) Foreign Application Priority Data
Nov. 22, 2021 (DE) 10 2021 213 124.7

(51) Int. Cl. B29C 48/92; B29C 48/00; B29C 48/10; B29C 48/88

(52) U.S. Cl. CPC B29C 48/92; B29C 48/0018; B29C 48/10; B29C 48/912; B29C 2948/92057; B29C 2948/92209; B29C 2948/92295; B29C 2948/92428

(57) ABSTRACT

The invention describes a method for monitoring a film bubble (6) in an outlet region after it emerges from an outlet die and before it leaves a calibration apparatus of a blow film line, the method comprising the following steps:
detecting the wavelength of the radiation emitted from at least two different locations of the outer surface of the blown film at different points in time following one another by means of at least one optical sensor
determining locations of the same wavelength
determining the variation over time of the locations of the same wavelength.

The invention relates to a monitoring method according to claim 1 and a blow film line according to claim 8.

In a blown film plant, one or more plastic melts are produced from plastic granules in one or more extruders. The melt or melts are distributed inside a die head in a ring shape and guided out of the die head through an outlet die in the outlet region. The film bubble created in this way is drawn off via a draw-off, which comprises a pair of rollers with at least one driven roller. Downstream of the outlet die the blown film is typically cooled on the inside and/or outside by means of cooling devices, so that the melt solidifies. Typically, the film bubble is stretched in the transport direction and/or in the radial direction by the draw-off and/or by an overpressure prevailing within the film bubble. After a certain transport distance, the film bubble has solidified to such an extent that it can no longer be significantly deformed. This transition is called the frost zone, the area between the outlet region and the frost zone is often referred to as the tube formation zone. Before the film bubble passes the draw-off, it is guided through a calibration apparatus, which is preferably located downstream of the frost zone. A laying-flat device may also be located between the calibration apparatus and draw-off, which gently converts the film bubble into a double flat web over a longer transport distance.

The way in which the film bubble is influenced between the outlet die and the calibration apparatus plays a decisive role in the quality and properties of the film that is later produced from the film bubble. The film bubble may be influenced intentionally, but also unintentionally. A disadvantageous influence on the film bubble is to be avoided. It is therefore desirable to already characterize the film bubble between the outlet region and the calibration apparatus. This way, remedial action can be taken in the event of a disadvantageous influence.

The object thus is to propose a method and a device for improved characterization of the film bubble.

The above object is accomplished by a method having the features of claim 1 and a blow film line having the features of claim 8. Further features and details of the invention derive from the dependent claims, the description and the figures. Features and details which are described in the context of the method according to the invention naturally also apply in the context of the blow film line according to the invention and vice versa, respectively, so that reference is or can always be made to the individual aspects of the invention reciprocally with respect to the disclosure.

The invention relates to a method for monitoring a film bubble in an outlet region after exiting from an outlet die and before leaving a calibration apparatus of a blow film device. According to the invention, the following steps are carried out:
Detecting the intensity of the radiation emitted from at least two different locations on the outer surface of the blown film at different, consecutive points in time by means of at least one optical sensor
Determining locations of equal intensity;
Determining the temporal progression of the locations of equal intensity.

The detection is carried out by at least one detector with which the electromagnetic radiation emitted by the blown film can be detected or is detected. The intensity is measured in particular within a defined wavelength range (the so-called measurement window), for which the at least one detector is preferably optimized. The measurement window preferably covers a wavelength range from 1 μm to 30 μm, in particular from 2 μm to 30 μm.

The electromagnetic radiation may be in the so-called infrared range, where the wavelength is between 780 nm and 1 mm, but also in the range that is visible to humans (wave length between 380 nm and 780 nm) or in the high-energy range (UV radiation, wavelength below 380 nm).

Typically, the infrared radiation is radiation that occurs in the blown film itself, which is attributable to thermal radiation. The materials contained in plastic films generate radiation at characteristic wavelengths, which are material-dependent. The intensity of the respective radiation depends on the temperature of said material. The measurement window preferably covers at least a wavelength range from 1 μm to 30 μm, in particular from 2 μm to 30 μm. The visible and high-energy radiation is typically generated in a light source provided for this purpose and which is reflected or transmitted by the film bubble. By using radiation at different wavelengths, different properties of the film bubble can be examined. Visible radiation can be used, for example, to make defects of the film bubble, such as stripes or specks, visible. The radiation in the infrared range originates at least partially from the thermal radiation of the film bubble. The intensity of said radiation in the measurement window is therefore an indicator of the temperature of the film bubble.

The core idea of the invention is to use at least one detector to record or measure the electromagnetic radiation that emanates from different locations of the film bubble, in particular, from locations on the outer surface, be it through intrinsic radiation, reflection and/or transmission. This makes it possible to characterize the film bubble at two different locations with regard to certain properties, in particular the temperature.

In particular, it is further provided that the measurement described above is repeated at different, consecutive points in time. Overall, it is thus possible to not only carry out a characterization of the film bubble at different locations, but to also track the development of the measured values over time, i.e., the measured intensity. In the case of the chronologically subsequent measurements, these are preferably carried out at the same locations or at almost the same locations as previous measurements.

Furthermore, according to the invention, it is provided to determine locations of equal intensity. This can be done, in particular, by interpolating the intensities that have been measured at the specified locations.

For a further characterization of the film bubble, it is provided according to the invention to determine a temporal progression from the locations of equal intensity. Accordingly, the locations of equal intensities can be tracked over time.

Overall, the described detection and evaluation of the radiation with specific intensities, which emanates from different locations, can result in a better characterization of the film bubble at different points in time. Not just one of location or time dependency must be determined, but both. In particular, if the detected radiation is used to infer the relative temperature or the absolute temperature of the film bubble, different conditions that affect the temperature can be inferred. This makes it possible to output information, for example a warning, and/or to take suitable countermeasures, for example in the form of a warning. Furthermore, the method according to the invention makes it possible to recognize the outer shape, i.e., a two-dimensional contour of the film bubble. At the edges of the film bubble, the measured intensity of a given wavelength changes to substantially zero (ignoring background radiation and other extraneous influences), so that said edges can be reliably determined. The determination of edges of the film bubble makes it possible to use the temporal progression of said edges for further characterization of the film bubble. If the locations, i.e., the positions of the edges, change over time, this can indicate that the film bubble is not being produced in a consistent manner.

A change in the locations of the edges over time, in particular the deflection of the edges of the film bubble from ideal profiles, is an often observed effect and is referred to as fluttering. By determining the edges of the film bubble, the development of fluttering over time can be observed. In particular, fluttering in the outlet region is decisive for the stability of the film bubble. If the deflections of the edges exceed a predetermined value, generally and/or specifically in the outlet region, in particular process and/or machine parameters are adjusted to minimize the deflection. The film bubble can also be divided into height zones by the open-loop and/or closed-loop control device, in which the fluttering is observed separately in each case, with a separate deviation value, from which the parameters are adjusted, being specifiable for each zone. Alternatively or additionally, a warning signal is issued to the machine operator.

It is advantageous if the measurement of the locations with equal intensity is related to the transport direction and/or the geometric symmetry of the film bubble. In particular, based on the locations of equal intensity, a comparison can be made with the geometric symmetry of the film bubble, which results from the edges of the film bubble. Deviations in the axes of symmetry or planes of symmetry indicate, in particular, an uneven cooling behavior of the film bubble, so that further measures can be taken. For example, it is conceivable to issue a warning signal to the operator. Instead of or in addition to comparing the symmetries, the locations of the inflection points of the edges or the angles of the inflection points relative to the nominal or desired axis of symmetry can be used (which is usually given by the arrangement of the center of the outlet die and the axis of symmetry of the calibration apparatus) can be compared, for example.

In a further development of the invention, it is provided that a mean value line is formed for the locations of equal wavelength for a specific point in time. The provision that said mean value line is perpendicular to the transport direction of the film bubble is, in particular, taken into account. Such a mean value line can then also be referred to as a contour line. In this way, it can already be estimated to what extent a location from which radiation of this wavelength emanates deviates from the mean value. This makes it possible, for example, to assess whether the cooling behavior of the film bubble is homogeneous or inhomogeneous. If the deviations are too great, a warning signal can be issued, for example. Additionally or alternatively, the evaluation can be used to set up a control loop in which the film bubble can be tempered differently over its circumference to keep the deviations below a deviation limit value.

At least one of the following elements and/or its settings of a blow film line can be influenced to influence the temperature behavior of the film bubble: external air application device, internal air application device, height of the multi-layered cooling section as viewed in the transport direction of the film bubble, volume flow and/or temperature of the air, which are given by the aforementioned elements to the film bubble, position of the calibration cage, process parameters that influence the cooling rate, in particular the material throughput.

It is advantageous if the deviations of the locations with equal intensity from a mean value line are assigned to one of the following categories:
dynamic deviations (deviations with changes over time);
stationary deviations (deviations without changes over time)

Consequently, the deviation of the locations of equal intensities from the mean value line over time is considered. A dynamic deviation is a deviation with changes over time, whereas stationary deviations are those that experience little or no change over time. Dynamic deviations can be caused, for example, by moving disturbance variables, for example, by a walking person who is detected by the detector. A stationary deviation can be caused, for example, by a stationary disturbance variable that influences the intensity of the measured radiation. This can be a temperature control element such as the internal cooling unit of the blown film line.

To be able to carry out the classification described above, tolerance limits are defined, in particular, around the mean value line. As long as said tolerance limits are undercut, an assignment to the category of stationary deviations takes place. In the other case, an assignment to the dynamic deviations takes place. In this way, it is possible to compensate for stationary deviations, for example, through one-time changes in the recipe, process and/or machine parameters. In the case of dynamic deviations, these must be examined regularly and compensated as necessary or regularly.

Furthermore, it is advantageous if the temporal progression of locations of equal intensities is compared for at least two different intensities. In particular, the actual curve shapes can be compared with one another. However, deviations from the mean value line can be compared with each other, in particular, after such a deviation has occurred. If the comparison is also carried out for equal angular positions in relation to the circumferential direction of the film bubble, it is not only possible to determine the propagation of the deviation in relation to the transport direction, but also transversely to it, so that the search for causes of the deviations is made easier.

The distance between the locations of equal intensity and/or their mean value lines per intensity interval and/or per temperature interval derived therefrom can be a measure of the cooling rate of the film bubble at said locations. In particular, temperature gradients for the film bubble can be derived. In turn, the location of the frost zone of the film bubble can be determined from a characteristic progression of a temperature gradient. If several characteristic curves can be derived from a temperature gradient, several frost zones can also be inferred. The temperature of a plastic melt is usually varied at the respective extruder and/or within the die head. It is therefore advantageous to change the melt temperature of at least one plastic melt so that the frost lines of at least the second plastic melt are substantially at a common height.

If the temporal progression of locations with equal intensities for dynamic changes is compared and local propagations of the changes are determined from this, then it is advantageous to also determine the speed of propagation of the change. Such a determination can help identify impending problems and/or faults at an early stage. For example, rapid propagation can indicate an imminent bubble tear-off. Appropriate warnings can be issued and/or countermeasures initiated.

Furthermore, by observing the dynamic changes when at least one material that is fed to one of the extruders is changed, it is possible to determine when the new material in the film bubble has had a predominant influence on the intensities to be determined and thus, in particular, on the temperature. It is thus possible to estimate when a material change has been successfully carried out.

Based on the cooling behavior of the film bubble, which is determined using the method according to the invention, it is advantageous if a comparison with the cooling behavior of earlier production orders is made. In this way, for example, an automatic product recognition can be carried out. It is also made possible to compare the current production order with a previous production order with the same recipe to be able to determine deviations. It is, in particular, provided to issue a warning message to the machine operator.

In a further advantageous embodiment of the invention, at least one deviation is assigned to a cause of a fault. In particular, it is provided that a cause of a fault is determined for stationary deviations. Such a cause of a fault may be, for example, a body which itself emits electromagnetic radiation, which arises, in particular, as a result of its own temperature. This additional radiation leads to a change in the measurement, since now not only the radiation of the film bubble is detected. Such a change in radiation can now be compensated for by simply subtracting the additional radiation. This makes it easier to recognize subsequent dynamic deviations. To be able to carry out a subtraction, the radiation of the body can be measured without a film bubble and/or the radiation can be determined on the basis of the temperature of the body.

In particular in the case of dynamic deviations, deviations can be linked in terms of time to changes in the recipe, process and/or machine parameters. For example, a temperature change at one of the extruders can lead to a change in the intensity of the radiation emitted by the film bubble with a time delay. An open-loop and closed-loop control device of the blow film line on which the method is carried out can use this data and data relating to the transport speed of the melt and/or the film bubble to establish this relationship and thus the assignment.

It is further advantageous if a stationary deviation is assigned to an element of the blow film device. In this case, a pattern of the deviations from the mean value line can be determined at a certain point in time or for several points in time for several locations of equal intensities and compared to the shapes of components of the blow film line to be able to determine the component responsible for the deviations. In this way, the influence caused by this component on the measured radiation intensity can be taken into account and, in particular, compensated.

In addition, it is advantageous if stationary deviations, which are attributable to permanent causes, are stored in a memory device of the blow film line and are taken into account, in particular, for subsequent production orders. For example, the influences of bodies described above, for example components of the blow film line, can be taken into account right from the start of processing the production order, without first having to identify this influence. This can result in a reduction of rejects.

In an advantageous embodiment of the invention, a display device is provided on which the locations of equal intensities are shown. Said locations of equal intensities are preferably represented as curves. The areas between two such curves are preferably shown in color, with a red coloring preferably being used with high intensities, which, following the usual spectral colors, change to a blue coloring as the intensity decreases.

For an improved representation on the display device, an automatic contrast control of the representation can be carried out. The brightness of the display is changed locally to display differences more clearly. This serves to improve the recognizability, in particular of deviations and faults.

The above-mentioned object is additionally achieved by a blow film line for producing and monitoring a film bubble, comprising an outlet die, from the outlet region of which the film bubble can be guided out and comprising a calibration apparatus arranged downstream of the outlet die, through which the blown film can be guided, further comprising:
a detection apparatus for detecting the intensity of the radiation emitted from at least two different locations on the outer surface of the blown film at different, successive points in time by means of at least one optical sensor and for converting the detected intensities into electrical signals;
a computing device for receiving and processing the electrical signals, wherein locations of equal intensities can be determined using the computing device and wherein the temporal progression of the locations of equal intensities can be determined with the computing device.

The same advantages can thus be achieved which have already been described above in connection with the monitoring method according to the invention.

Further advantages, features and details of the invention are shown in the following description, in which various exemplary embodiments are explained in detail with reference to the figures. The features mentioned in the claims and in the description can each be essential to the invention individually or in any combination of features mentioned. Within the scope of the entire disclosure, features and details that are described in connection with the method according to the invention naturally also apply in connection with the blow film line according to the invention and vice versa, so that reference is or can always be made reciprocally to the individual aspects of the invention with regard to the disclosure. The individual figures show:

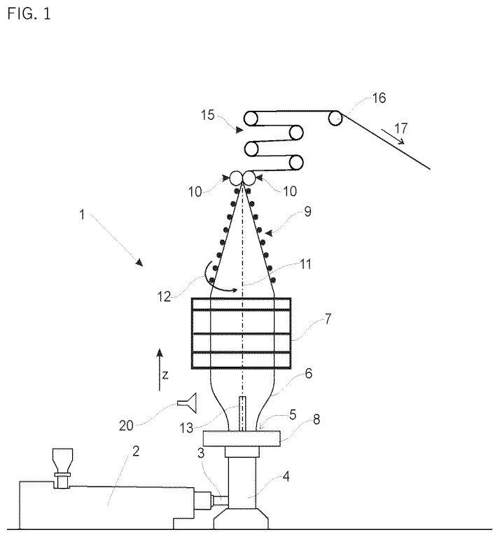

FIG. 1 a side view of a blow film line according to the invention;

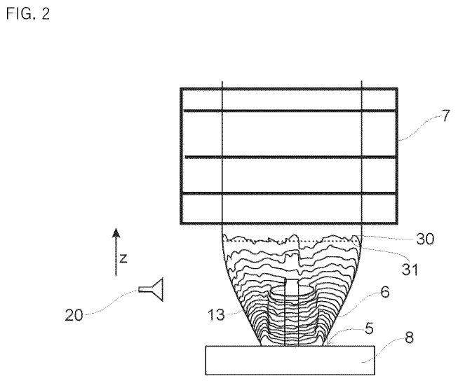

FIG. 2 a section from FIG. 1 showing locations with equal wavelength.

FIG. 1 shows a device 1 for manufacturing a tubular film, namely a blow film line 1 which firstly comprises at least one extruder 2 with which plastics material present in granular form, for example, can be plasticized. The plastic melt produced in this way is fed via a line 3 to a die head 4, from which this melt is transformed into a film bubble 6, so that this melt stream can be drawn out of an annular die 5, which is not visible in this figure, in the draw-off direction z. Now there is a film bubble 6 that has not yet solidified. Said film bubble is inflated in the tube forming zone from the inside by a slight overpressure so that it has a larger diameter inside the calibration apparatus 7. For this purpose, an air supply apparatus 13 is provided, which is located within the annular die 5 and extends partially in the direction of transport. Said air supply apparatus is supplied with air guided through the extrusion tool.

The film bubble solidifies by cooling, in particular by a tempering device 8, which is often also referred to as a cooling ring because of its ring-like configuration enclosing the tubular film, with part of the heat of the film bubble being given off to the environment.

After passing through the calibration apparatus 7, the film bubble 6 enters the effective working region of a laying-flat device 9, in which the circular tubular film is transformed into an elliptical cross-section with increasing eccentricity until it finally forms a double-layer plastic film, which is joined together at its sides, in the region of influence of the draw-off device, which comprises, in particular, two draw-off rollers 10.

The laying-flat device is rotatably arranged, wherein the axis of rotation is substantially flush with the tube axis or axis of symmetry 11, which is indicated in FIG. 1 as a dot-dashed line. The rotatability of the laying-flat device is indicated with the arrow 12.

FIG. 1 furthermore shows a reversing apparatus 15, the task of which is to guide the laid-flat tubular film from the laying-flat device to the fixed roller 16 without damages occurring.

The arrow 17 indicates that, after passing through the reversing apparatus 15, said tubular film is guided to further processing, which is not specified in detail here.

As viewed in the transport direction z, at least one detection apparatus 20 is arranged between the annular die 5 and the calibration cage 7, with which detection apparatus at least partial surface areas of the surface of the film bubble 6 can be detected. The detection apparatus 20 is arranged outside of the film bubble 6, but directed toward it. The detection apparatus 20 may be directly or indirectly fasten to any component of the blow film line 1. It is, however, also conceivable to setup the detection apparatus 20 independently from the blow film line 1 on its own stand, for example a tripod, within the production facility.

FIG. 2 now shows a section of FIG. 1, substantially showing the film bubble 6 in the tube formation zone and the annular die 5, the temperature control device 8, the calibration apparatus 7 and the detection apparatus 20.

The detection apparatus 20 comprises, in particular, at least 32 detection elements so that a sufficient number of points on the circumference of the tubular film can be detected simultaneously. For example, the detector has at least a so-called VGA resolution, i.e., at least 320 detection elements per side direction. A detector preferably has a refresh rate of at least 3 Hz, preferably at least 9 Hz, i.e., that at least three and preferably at least nine detections can be carried out per second with each detection element. Each of the detection elements is able to measure the associated intensity for one or more wavelength ranges. In particular in the infrared radiation range, the radiation intensity is measured for each of these wavelength ranges and a temperature of the tubular film is then derived from this.

As shown, a detection device 20 may be provided. However, to be able to scan a larger circumferential area, it is advantageous to design the detection apparatus 20 to be movable around in the circumferential direction of the film bubble. Alternatively or additionally, at least one second detection apparatus can be provided, with which surface areas of the surface of the film bubble 6 can be scanned, which at least partially cannot be scanned by the first detection device 20.

FIG. 2 now shows the locations of equal intensity or equal temperature, the individual locations being connected to one another by a line 30. A number of such lines is shown, but these have not been given individual reference numerals. Each of these lines thus represents the intensities or temperature profile on the surface of the film base 6, with the first line, viewed in the transport direction, representing the highest temperature and the last line representing the lowest temperature.

The interrupted line 31 represents a mean value line with which the mean location of the associated line 30 is represented. Said line 31 extends orthogonally to the transport direction z and can therefore also be referred to as a contour line.

FIG. 2 shows as an example how elements of the blow film line 1 influence the temperatures of the film bubble 6 and thus the progression of the locations of equal temperature. In the region of the air supply apparatus 13 it can be seen that the lines run strongly in the opposite direction to the transport direction z. This means that the film bubble 6 has a higher temperature in this region.

In one case, which has just been explained as an example, it is shown that the detection apparatus 20 and optionally other existing detection apparatuses not only detect the radiation from the film bubble 6, but that the detected signal represents a superimposition of the radiation from the film bubble 6 and the radiation of various other bodies. One aspect of the present invention is to take into account the influences of other bodies and, in particular, to subtract them when evaluating the measurements.

List of reference signs

1
2
3
4
5
6
7
8
9
10
11
12
13
14
15
16
17
18
19
20
21
22
23
24

1. A method for monitoring a film bubble (6) in an outlet region after exiting an outlet die (5) and before leaving a calibration apparatus of a blown film device (1), having the following steps:
Detecting the intensities of the radiation emitted from at least two different locations on the outer surface of the blown film by means of at least one optical sensor at different, consecutive points in time
Determining locations of equal intensities;
Determining the temporal progression of the locations of equal intensities.

2. The method according to claim 1, additionally comprising the following step: Determining at least one deviation of the locations of equal intensities from a mean value line, which runs through the mean value of the locations in the transport direction of the film in the horizontal direction, at different points in time.

3. The method according to claim 1, additionally comprising the following step:
Assigning the deviations to one of the following categories:
dynamic deviations (deviations with changes over time);
stationary deviations (deviations without changes over time)

4. The method according to claim 1, additionally comprising the following step:
Comparing the temporal progression of locations of equal intensities for at least two different intensities.

5. The method according to claim 1, additionally comprising the following step:
Assigning at least one deviation to a cause of a fault.

6. The method according to claim 1, additionally comprising the following step:
Assigning a stationary deviation to an element of the blown film device.

7. The method according to claim 1, additionally comprising the following step:
Considering the influence of an element of the blown film device when determining deviations of the locations of equal intensities from the mean line.

8. A blow film line for producing and monitoring a film bubble, comprising an outlet die, from the outlet region of which the film bubble can be guided out and comprising a calibration apparatus arranged downstream of the outlet die, through which the blown film can be guided, further comprising:
a detection apparatus for detecting the intensities of the radiation emitted from at least two different locations on the outer surface of the blown film at different, successive points in time by means of at least one optical sensor and for converting the detected intensities into electrical signals;
a computing device for receiving and processing the electrical signals, wherein locations of equal intensities can be determined using the computing device, and,
wherein the temporal progression of the locations of equal intensities can be determined with the computing device.
